(19) United States
(12) Patent Application Publication
(10) Pub. No.: US 2012/0066971 A1
(43) Pub. Date: Mar. 22, 2012

(54) Water Supply Device for Planting Container

(76) Inventor: Paul Lin, Taichung City (TW)

(21) Appl. No.: 13/017,167

(22) Filed: Jan. 31, 2011

(30) Foreign Application Priority Data
Sep. 17, 2010 (TW) 099218038

(51) Int. Cl. A01G 9/02

(52) U.S. Cl. 47/80

(57) ABSTRACT

A water supply device for a planting container comprises a main body having a water storage space and a water supply space. A water supply hole is disposed between the water storage space and the water supply space. Water in the water storage space is transported to the water supply space through the water supply hole. A water absorbing material is disposed in the water supply space and utilizes siphon principle to pump the water in the water supply space. When the water level of the water supply space is higher than the water supply hole, a vacuum effect is generated. When the water level of the water supply space is lower than the water supply hole, the vacuum effect is released so that water in the water storage space is transported to the water supply space through the water supply hole.

### BACKGROUND OF THE INVENTION

1. Field of the Invention

The present invention relates to a planting container, and more particularly to a water supply device for a planting container.

2. Description of the Related Art

A conventional flowerpot structure having automatic water supply function, as shown in FIG. 8, is stacked with an internal body 511 and an external body 512 to form a flowerpot body 51. A water storage space 52 is formed in the flowerpot body 51, and a water absorbing material 53 communicating with the water storage space 52 is disposed in the bottom of the internal body 511 so that one end of the water absorbing material 53 to absorb water in the water storage space 52. Another end of the water absorbing material 53 is directly in contact with culturing soil so as to achieve the goal of supplying water to plants.

As shown in FIG. 9, another conventional flowerpot structure having automatic water supply function is composed of stacking a first container 61 and a second container 62. The first container 61 is filled with predetermined quantity of water. The second container 62 is disposed on the first container 61, and a protruding portion 63 forming a funnel is extended into water in the first container 61 from the bottom of the second container 62. The protruding portion 6 is provided with a hole 64 to form a water containing structure so that water of the first container can be delivered to the second container 62, thereby achieving the goal of supplying water.

Although the foregoing two conventional flowerpot structures having automatic water supply function have efficacies of storing water and supplying water, the water supply quantity supplied to the culturing soil may not be effectively controlled. Consequently, water supply state is continued all the time due to the water pumping of the culturing soil, and the culturing soil is too wet, resulting in easily decaying at roots of plants.

Moreover, the conventional flowerpot structures having automatic water supply function may not be directly applied to a normal flowerpot. Namely, if consumers would like to acquire the flowerpot having automatic water supply function, only the flowerpot structure having automatic water supply function can be purchased. Other flowerpots that do not provide automatic water supply function must be discarded to cause waste and may not satisfy the environmental protection either.

### SUMMARY OF THE INVENTION

In view of the shortcomings of the prior art, the inventor(s) of the present invention based on years of experience in the related industry to conduct extensive researches and experiments, and finally developed a water supply device for planting container.

Therefore, it is a primary objective of the present invention to overcome the aforementioned shortcoming and deficiency of the prior art by providing a water supply device for planting container having the efficacy of automatically regulating water supply quantity based upon the condition in which plants absorb water contents.

It is a second objective of the present invention to provide a water supply device for planting container that can be directly applied to a normal flowerpot to have the function of automatically supplying water and that can be continuously utilized in the normal flowerpot without waste.

To achieve the foregoing objectives, the water supply device for the planting container provided by the invention comprises:

a main body internally defined to form a water storage space capable of containing predetermined water quantity and a water supply space, a water inlet pipe, which communicates with the water storage space, upwardly extended from the main body, a sealing cap covering a top of the water inlet pipe to form an airtight state, a water supply hole disposed between the water storage space and the water supply space so that water in the water storage space can be transported to the water supply space through the water supply hole;
A water absorbing material, wherein one end of the water absorbing material is inserted into the water supply space relatively located near the water supply hole, and another end of the water absorbing material is exposed to an exterior of the main body, and the water absorbing material utilizes siphon principle to pump water in the water supply space and lowers a water level of the water supply space, and when the water level of the water supply space is higher than the water supply hole, the water storage space generates a vacuum effect, and when the water level of the water supply space is lower than the water supply hole, the vacuum effect of the water storage space is released so that water in the water storage space is smoothly transported to the water supply space through the water supply hole.

### BRIEF DESCRIPTION OF THE DRAWINGS

FIG. 1 is a structural diagram according to a first embodiment of the present invention;

FIG. 2 is a schematic diagram of a using state according to a first embodiment of the present invention;

FIG. 3 is a schematic diagram of an acting state according to a first embodiment of the present invention showing the state that stops supplying water when the water level of the water supply space is higher than the water supply hole;

FIG. 4 is a schematic diagram of an acting state according to a first embodiment of the present invention to show the state that supplies water when the water level of the water supply space is lower than the water supply hole;

FIG. 5 is a structural diagram according to a second embodiment of the present invention;

FIG. 6 is a structural diagram according to a third embodiment of the present invention;

FIG. 7 is a structural diagram of a using state according to a third embodiment of the present invention;

FIG. 8 is a structural diagram of a conventional flowerpot having automatic water supply function;

FIG. 9 is a structural diagram of another conventional flowerpot having automatic water supply function.

### DETAILED DESCRIPTION OF THE PREFERRED EMBODIMENTS

The foregoing and other technical characteristics of the present invention will become apparent with the detailed description of the preferred embodiments and the illustration of the related drawings.

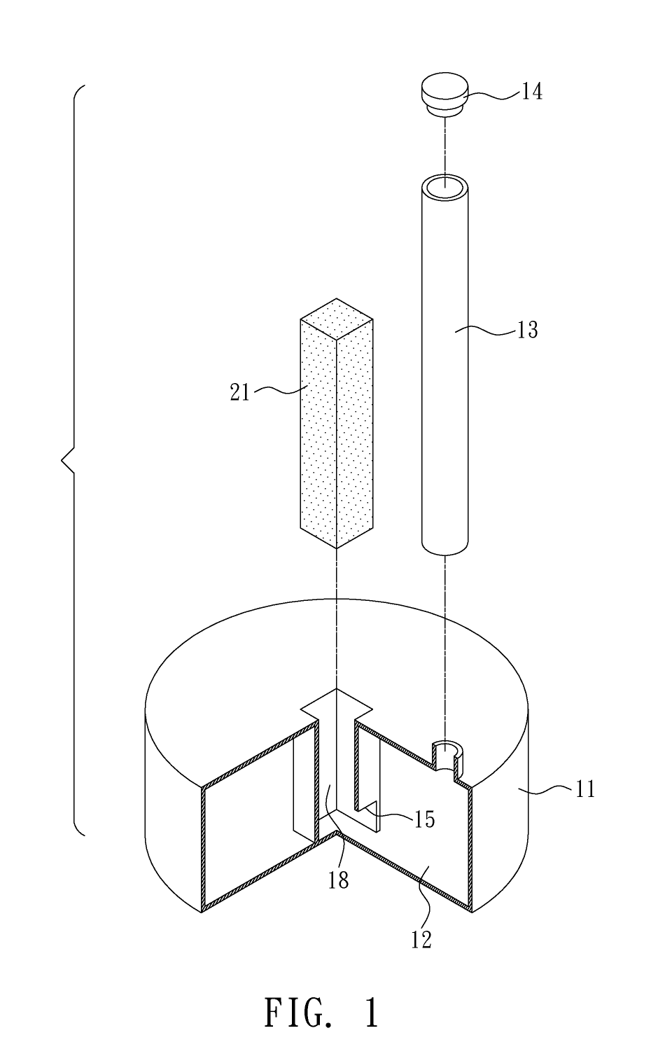

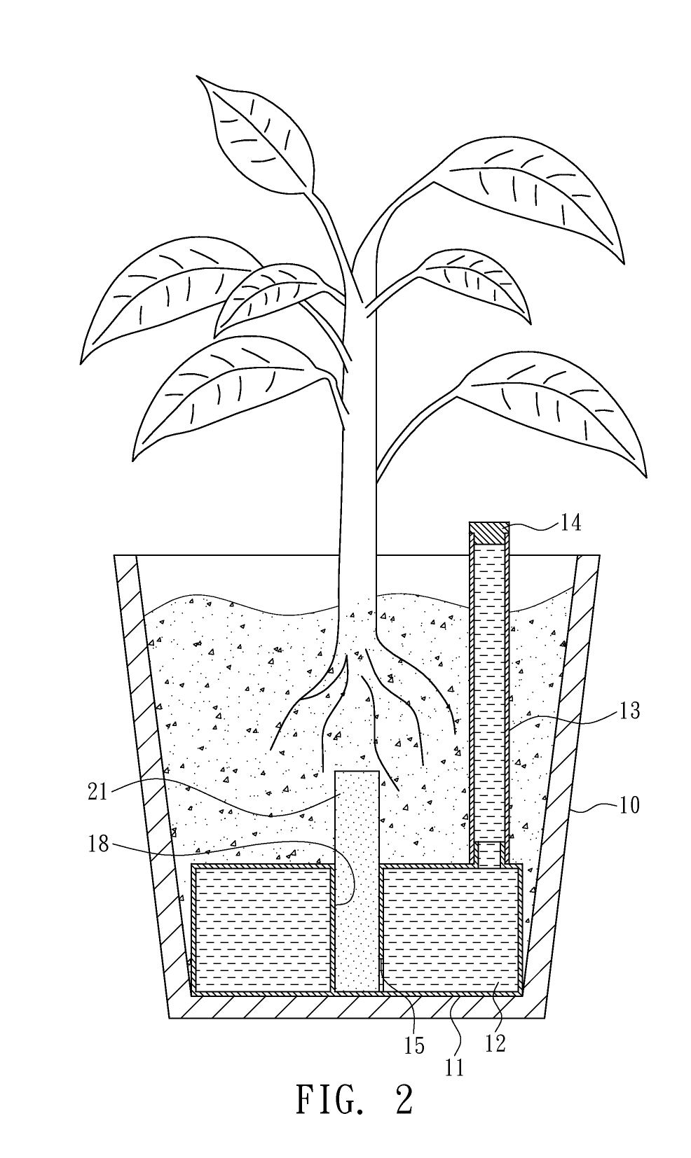

Firstly, with reference to FIG. 1 to FIG. 2 for a water supply device for a planting container in accordance with a first embodiment of the invention is directly contained in a planting container 10 to allow the planting container 10 to have automatic water supply function. The water supply device is mainly composed of a main body 11 and a water absorbing material 21.

The main body 11 is a hollow casing and defined with a water storage space 12 capable of containing a predetermined water quantity and a water supply space 18 therein. A water inlet pipe 13, which communicates with the water storage space 12 and is provided for injecting water source, is upwardly extended from the main body 11. The top of the water inlet pipe 13 is exposed to the culturing soil, and the length of the water inlet pipe 13 can be extended to increase the water storage quantity based upon the real demands. The top of the water inlet pipe 13 is covered with a sealing cap 14 to form an airtight state. A water supply hole 15 is disposed between the water storage space 12 and the water supply space 18, and water in the water storage space 12 is transported to the water supply space 18 through the water supply hole 15. The water absorbing material 21 is composed of water absorbing foam. One end of the water absorbing material 21 is correspondingly inserted into the water supply space 18 of the main body 11 and relatively located near the water supply hole 15. Another end of the water absorbing material 21 is exposed to the exterior portion of the main body 11 for mutually contacting the culturing soil. The water absorbing material 21 utilizes siphon principle to pump water in the water supply space 18 to further lower the water level of the water supply space 18.

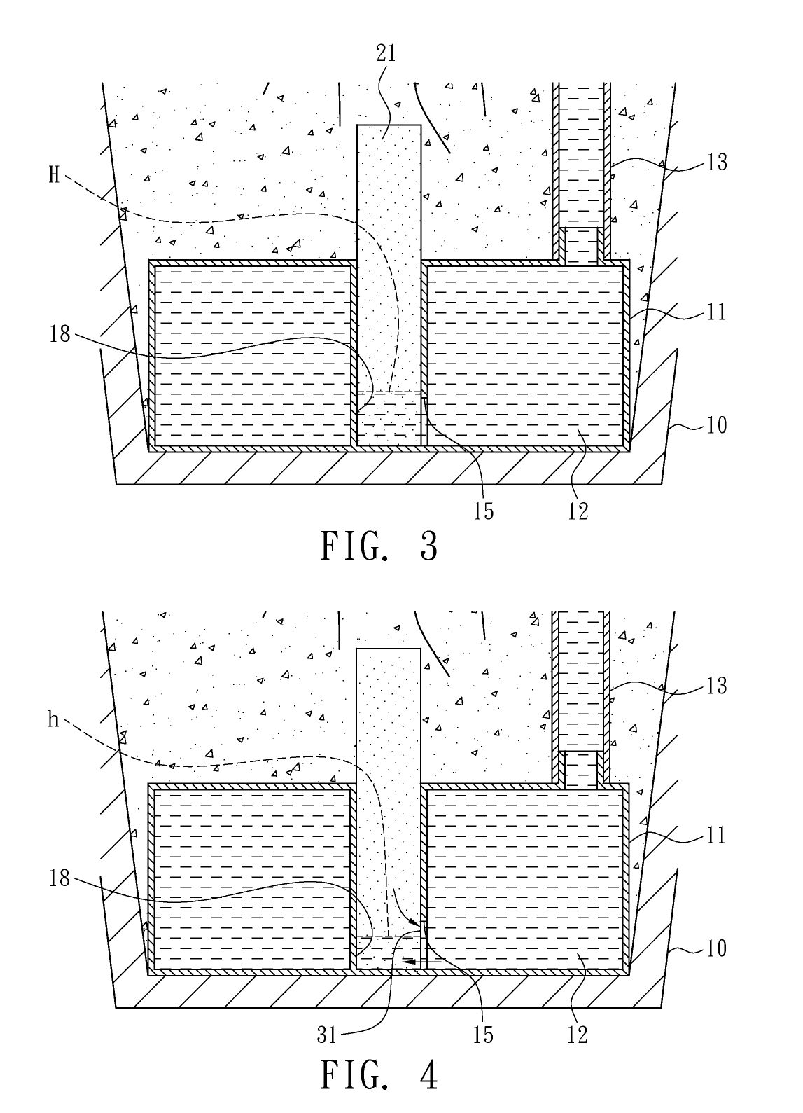

When the invention composed of the foregoing components is actually used, a user injects water into the water storage space 12 through the water inlet pipe 13 of the main body 11. The sealing cap 14 is covered on the top of the water inlet pipe 13 to form an airtight state. In the meantime, water in the water storage space 12 is transported to the water supply space 18 via the water supply hole 15. When the water level H transported to the water supply space 18 from the water supply hole 15 is higher than the water supply hole 15, as shown in FIG. 3, water in the water supply space 18 seals the water supply hole 15 to prevent air from entering the water storage space 12 and allows the water storage space 12 to generate a vacuum effect so that water in the water storage space 12 would not be transported to the water supply space 18 via the water supply hole 15.

The water absorbing material 21 utilizes the siphon principle to pump the water in the water supply space 18 and gradually lowers the water level of the water supply space 18 as shown in FIG. 4. When the water level h of the water supply space 18 is lower than the water supply hole 15, a gap 31 is produced from the water supply hole 15 to allow air entering the water storage space 12 to generate the convection, and the vacuum effect of the water storage space 12 can be released so that the water in the water storage space 12 can be smoothly transported to the water supply space 18 through the water supply hole 15. When the water absorbing material 21 is saturated and no longer to pump the water in the water supply space 18, the water level returns to the state as shown in FIG. 3.

When plants consume water content within the culturing soil, the culturing soil can be resupplied with water content through the water absorbing material 21, and the water absorbing material 21 utilizes the siphon principle to pump the water in the water supply space 18 again to lower the water level to achieve the goal of automatically supplying water. Accordingly, the invention can automatically regulate the water supply based upon the condition in which plants absorb water content to allow the plants to obtain proper water supply. Under the condition of having water in the water storage space 12, it does not need to water plants, and the plants may not decay at roots due to excessive water content or fade due to insufficient water content. The invention takes the water absorbing material 21 composed of water absorbing foam as the medium between water supply and the culturing soil. Since the water absorbing material 21 has excellent siphon effect, water can be properly and uniformly absorbed by the culturing soil in the planting container 10. The roots of the plants would breathe without the influence of the muddiness caused by faster water supply.

Moreover, the structural composition of the invention is quite simple to have the advantage of easy manufacture and low cost. The invention can be directly disposed in a normal planting container to allow the normal planting container having functions of automatically supplying water and automatically regulating water supply quantity, thereby providing extremely high practicality. Further, the normal planting container can be continuously utilized and does not need to throw away so as to match the environmental protection.

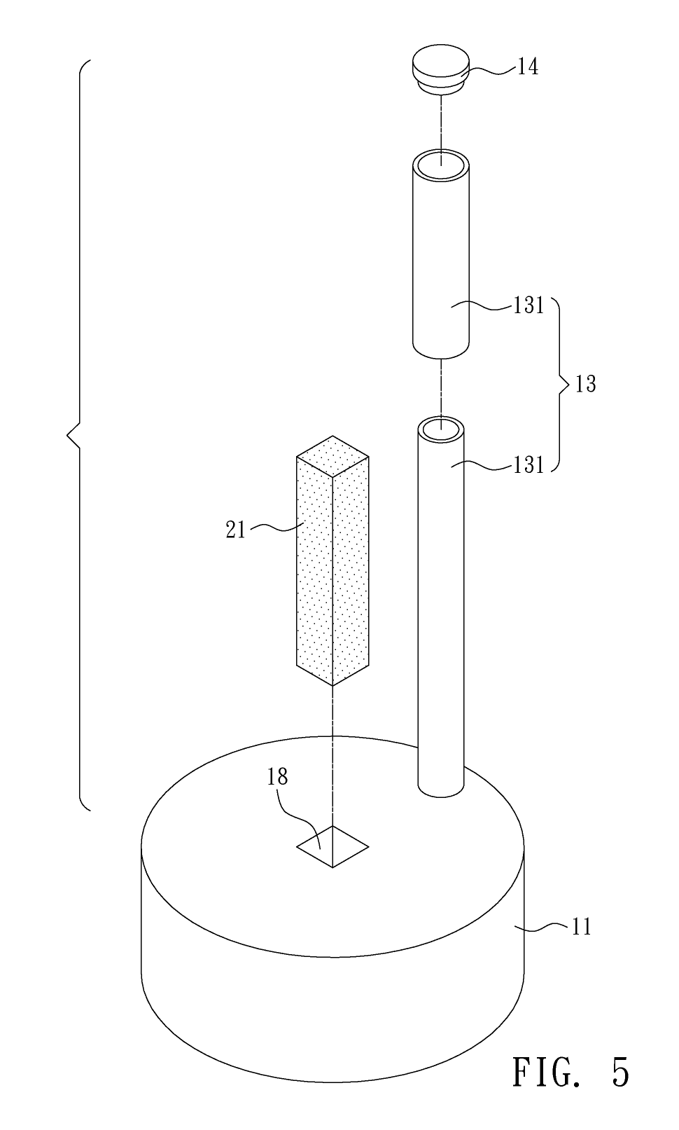

As shown in FIG. 5 for a second embodiment of the invention, the difference between the second embodiment and the first embodiment is that the water inlet pipe 13 is composed of mutually fitting two pipes 131, and the length of the water inlet pipe 131 can be increased according to actual demands.

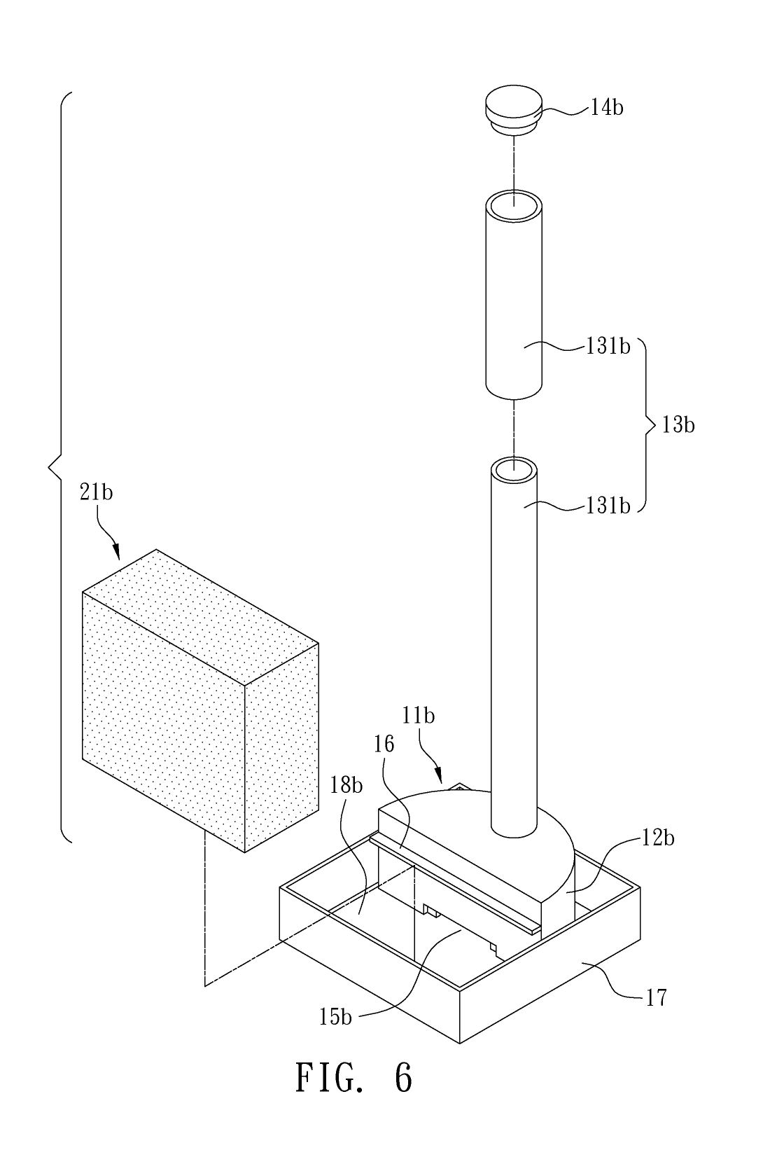

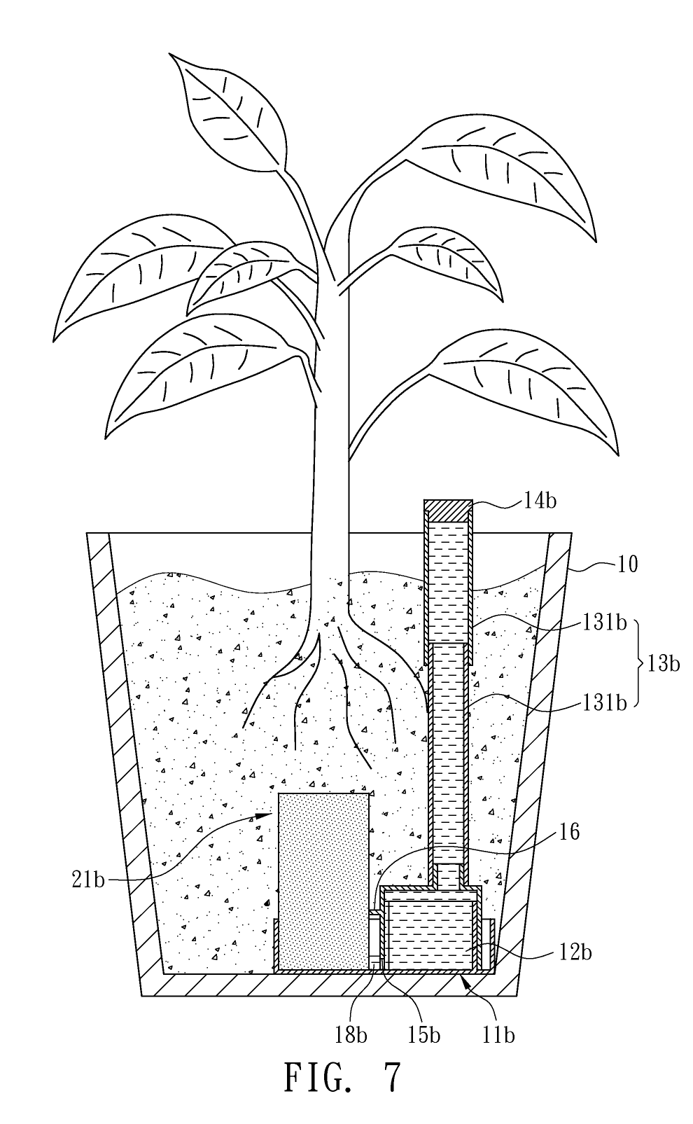

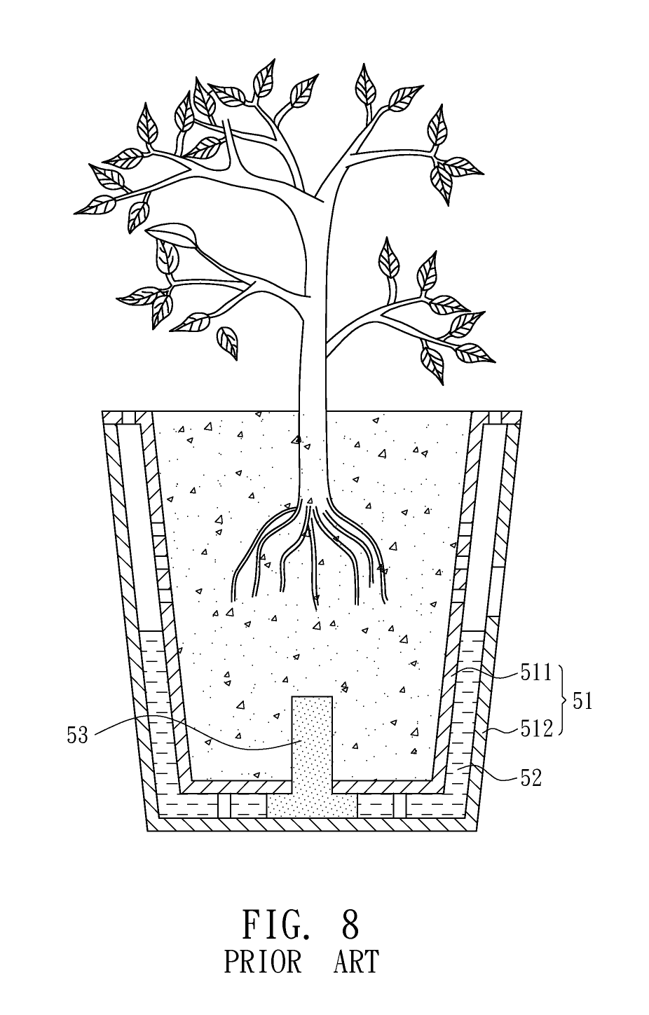

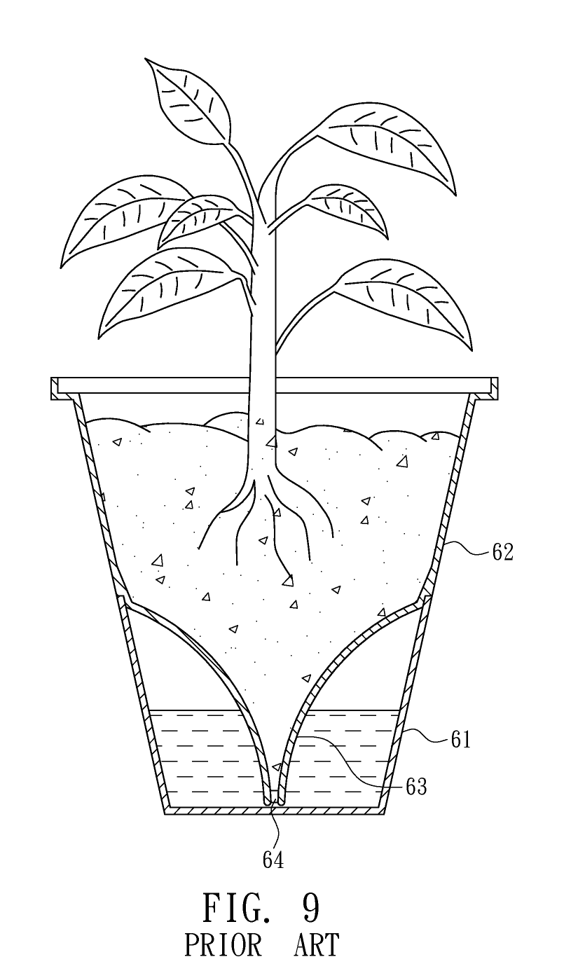

With reference to FIG. 6 and FIG. 7 for a third embodiment of the invention, the difference between the third embodiment and the foregoing embodiments is that the main body 11b has a water storage space 12b capable of containing predetermined water quantity. A bottom of the water storage space 12b is opened with a water supply hole 15b. An edge portion 16 that prevents the water supply hole 15b from being obstructed by the falling of the planting soil is protruded at the upper position of the water supply hole 15b. A wall 17 is surrounded at a periphery of the water storage space 12b, and a water supply space 18b is defined in the space of the wall 17 relative to the water supply hole 15b. The water in the water storage space 12b can be transported to the water supply space 18b through the water supply hole 15b. The water absorbing material 21 is disposed in the water supply space 18b of the main body 11b and relatively located near the water supply hole 15b. The edge portion 16 leans against a side of the water absorbing material 21b corresponding to the water supply hole 15b to have a proper distance between the water supply hole 15b and the water absorbing material. The water absorbing material 21b also utilizes the siphon principle to pump the water in the water supply space 18b and to lower the water level of the water supply space 18b so as to achieve the efficacy of automatically regulating water supply quantity as well as the first embodiment.

The present invention improves over the prior art and complies with patent application requirements, and thus is duly filed for patent application. While the invention has been described by device of specific embodiments, numerous modifications and variations could be made thereto by those generally skilled in the art without departing from the scope and spirit of the invention set forth in the claims.

What is claimed is:

1. A water supply device for a planting container comprising:
a main body internally defined to form a water storage space capable of containing predetermined water quantity and a water supply space, a water inlet pipe, for communicating the water storage space, upwardly extended from the main body, a water supply hole disposed between the water storage space and the water supply space so that water in the water storage space being transported to the water supply space through the water supply hole;
a water absorbing material, wherein one end of the water absorbing material is inserted into the water supply space and relatively located near the water supply hole, and another end of the water absorbing material is exposed to an exterior of the main body, and the water absorbing material utilizes a siphon principle to pump water in the water supply space and lowers a water level of the water supply space, and when the water level of the water supply space is higher than the water supply hole, the water storage space generates a vacuum effect, and when the water level of the water supply space is lower than the water supply hole, the vacuum effect of the water storage space is released so that water in the water storage space is smoothly transported to the water supply space through the water supply hole.

2. The water supply device for a planting container as recited in claim 1, wherein the water absorbing material is composed of water absorbing foam.

3. The water supply device for a planting container as recited in claim 1, wherein the water inlet pipe is composed of mutually fitting two pipes.

4. A water supply device for a planting container comprising:
a main body having a water storage space capable of containing predetermined water quantity, a water inlet pipe upwardly extended from the water storage space, a sealing cap covering a top of the water inlet pipe to form an airtight state, a water supply hole opened at a side of a bottom of the water storage space, a wall surrounded at a periphery of the water storage space, a water supply space defined in a space of the wall relative to the water supply hole so that water in the water storage space being transported to the water supply space through the water supply hole;
a water absorbing material disposed in the water supply space and relatively located near the water supply hole, the water absorbing material utilizing a siphon principle to pump water in the water supply space and lowering a water level of the water supply space, wherein when the water level of the water supply space is higher than the water supply hole, the water storage space generate a vacuum effect, and when the water level of the water supply space is lower than the water supply hole, the vacuum effect of the water storage space is released so that water in the water storage space is smoothly transported to the water supply space through the water supply hole.

5. The water supply device for a planting container as recited in claim 4, wherein an edge portion is protruded at an upper position of the water supply hole.

6. The water supply device for a planting container as recited in claim 5, wherein the edge portion leans against the water absorbing material to have a distance between the water supply hole and the water absorbing material.

7. The water supply device for a planting container as recited in claim 4, wherein the water inlet pipe is composed of mutually fitting two pipes.
